(19) United States
(12) Patent Application Publication
(10) Pub. No.: US 2025/0005826 A1
(43) Pub. Date: Jan. 2, 2025

(54) MOVING IMAGE GENERATION SYSTEM

(71) Applicant: TOYOTA JIDOSHA KABUSHIKI KAISHA, Toyota-shi (JP)

(72) Inventors: Yuko MIZUNO, Nagoya-shi (JP); Makoto MATSUSHITA, Ichinomiya-shi (JP); Hayato MIZUMA, Tokyo (JP); Kohei MIWA, Sunto-gun (JP); Naoki YAMADA, Kasugai-shi (JP)

(73) Assignee: TOYOTA JIDOSHA KABUSHIKI KAISHA, Toyota-shi (JP)

(21) Appl. No.: 18/621,284

(22) Filed: Mar. 29, 2024

(30) Foreign Application Priority Data
Jun. 29, 2023 (JP) 2023-106916

(51) Int. Cl. G06T 11/60; G06V 10/25; G06V 40/20

(52) U.S. Cl. CPC G06T 11/60; G06V 10/25; G06V 40/20; G06V 2201/07

(57) ABSTRACT

The moving image generation server acquires shot data during a load trip by a drive recorder mounted in the vehicle. The moving image generation server analyzes moving image and audio of the shot data. Then, the moving image generation server sets the clipping range based on the analysis result of the moving image and the audio. The moving image generation server automatically generates a moving image obtained by clipping an image of a clipping range from the shot data as a load trip movie.

### CROSS-REFERENCE TO RELATED APPLICATION

This application claims priority to Japanese Patent Application No. 2023-106916 filed on Jun. 29, 2023, incorporated herein by reference in its entirety.

### BACKGROUND

### 1. Technical Field

The disclosure relates to a moving image generation system.

### 2. Description of Related Art

Japanese Unexamined Patent Application Publication No. 2017-194950 (JP 2017-194950 A) describes a technology for automatically generating a road trip album, by automatically recording images and sounds inside and outside of a vehicle, based on analysis results of expressions and utterances of an occupant.

In the above-described conventional technology, expressions and utterances of the occupant have to be analyzed in real time in a traveling vehicle. Accordingly, an analysis system with high processing capabilities has to be installed in the vehicle.

### SUMMARY

A moving image generation system for solving the above problem sets a clipping range based on an analysis result of shooting data of a drive recorder, and also

automatically generates a moving image that is obtained by clipping an image of the clipping range from the shooting data.

The above moving image generation system has an effect of facilitating creation of a road trip movie.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an embodiment of a moving image generation system; and

FIG. 2 is a sequence diagram illustrating a moving image generation procedure in the moving image generation system.

### DETAILED DESCRIPTION OF EMBODIMENTS

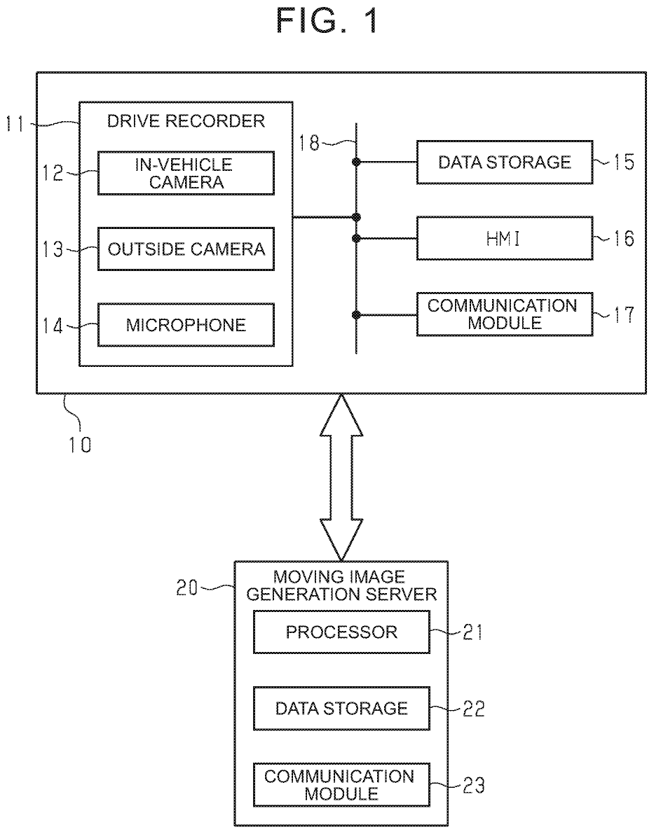

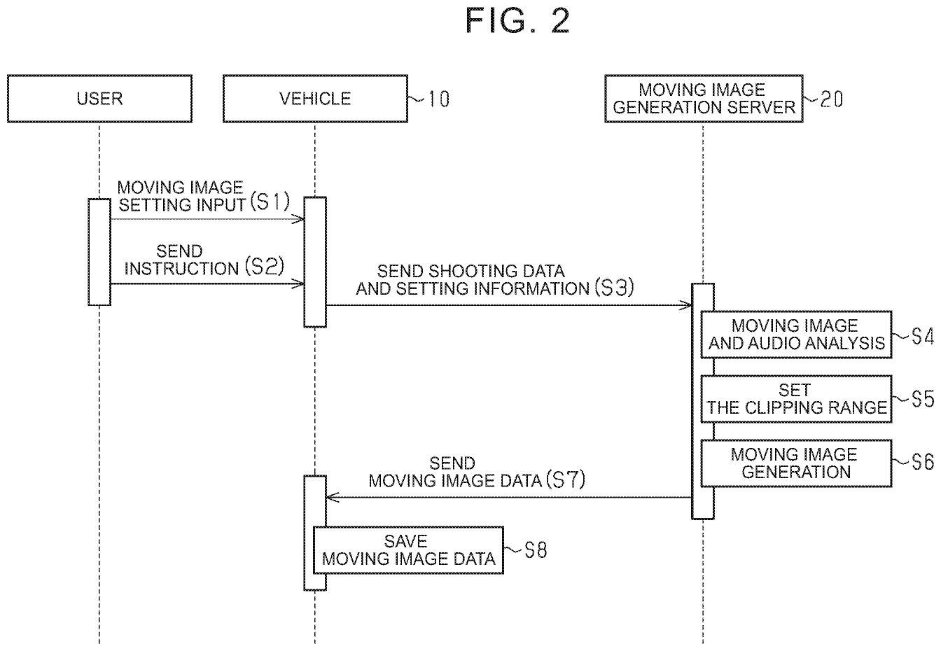

Hereinafter, an embodiment of a moving image generation system will be described in detail with reference to FIGS. 1 and 2.

### Configuration of Moving Image Generation System

First, a configuration of a moving image generation system according to the present embodiment will be described with reference to FIG. 1. The moving image generation system of the present embodiment automatically edits the moving image during the load trip shot by the drive recorder 11 and provides the edited moving image to the user of the vehicle 10.

As shown in FIG. 1, a drive recorder 11 is installed in a vehicle 10. The drive recorder 11 includes an in-vehicle camera 12 that shoots an image of the inside of the vehicle, an out-vehicle camera 13 that shoots an image of the outside of the vehicle, and a microphone 14 for recording sound inside the vehicle. In addition, the vehicle 10 is provided with a data storage 15 that records moving image shot by the in-vehicle camera 12 and the out-vehicle camera 13 of the drive recorder 11 and audio data recorded by the microphone 14. The data storage 15 may be built in the drive recorder 11 or may be installed outside the drive recorder 11.

Further, a human machine interface (HMI) 16 and communication module 17 is installed in the vehicle 10. HMI 16 is an interface that connects the vehicle 10 to an occupant. Exemplary HMI 16 include touch panel displays. The communication module 17 is an electronic component for performing wireless communication with the outside of the vehicle. The drive recorder 11, the data storage 15, HMI 16, and the communication module 17 are communicably connected to each other via an in-vehicle network 18.

The moving image generation system of the present embodiment automatically generates a road trip movie as a moving image based on the moving image shot by the drive recorder 11 of the vehicle 10. The moving image generation system includes a moving image generation server 20 which is a server device for generating a moving image. The moving image generation server 20 includes a processor 21 that performs various kinds of processing for generating a moving image, and a storage 22 that stores programs for generating a moving image and various kinds of data used for generating a moving image. The moving image generation server 20 includes a communication module 23 for performing data communication with the vehicle 10.

### About Generating a Load Trip Movie

Next, the automatic generation of the load trip movie according to the present embodiment will be described with reference to FIG. 2. The moving image generation system of the present embodiment creates a load trip movie based on the shot data of the drive recorder 11 during the load trip. The shot data of the drive recorder 11 includes moving image shot by the in-vehicle camera 12 and the outside-vehicle camera 13, and sound collected by the microphone 14. Further, the shooting data includes information of the shooting position and time of the moving image acquired from the on-board GPS device.

At the time of creating the road trip movie, the user of the vehicle 10 enters the moving image setting on HMI 16 (S1). The moving image setting is a specification of a moving image to be generated. Examples of the item of the moving image setting include a time of a moving image, a song title of a musical piece used as background music of the moving image, a title of the moving image, and the like. In addition, in the moving image setting, a person, a time, and a point to be included in the generated moving image are designated. Further, the user inputs the date and time of the load trip in the moving image setting. Thereafter, when the user of the vehicle 10 operates the transmission instruction on HMI 16 (S2), the information of the moving image setting input by the user in S1 is transmitted to the moving image generation server 20 together with the shot data during the load trip stored in the data storage 15 (S3).

The moving image generation server 20 performs moving image analysis and audio analysis of the received shot image data (S4), and sets a clipping range of the moving image based on the analysis result (S5). Subsequently, the moving image generation server 20 generates, as the moving image data of the load trip movie, a moving image edited so as to clip and connect the moving image of the clipping range from the shooting data during the load trip (S6). After that, the moving image generation server 20 transmit the generated moving image data to the vehicle 10 (S7). The vehicle 10 store the received moving image data in the data storage 15 (S8).

### Setting the Clipping Range

In S5 of FIG. 2, the setting of the clipping range performed by the moving image generation server 20 will be described. The moving image generation server 20 extracts a period in which the occupant of the vehicle 10 is in an elevated mood based on the analysis result of the moving image and the sound, and sets the period as a clipping range. Whether or not the occupant is in an elevated mood is determined by analyzing the expression and sound of the occupant. The music being played in the vehicle may be used as a criterion for determining whether or not the occupant is in an elevated mood. Specifically, the moving image generation server 20 analyzes the volume, the tone, or the song title of the music being reproduced in the vehicle, and uses the analysis result to determine whether or not the occupant is in an elevated mood.

In addition, the moving image generation server 20 sets the following moving image period as the clipping range.

When confirming that the occupant performs a predetermined gesture based on the analysis result of the moving image, the moving image generation server 20 sets a period of time at which the gesture is performed as a clipping range.

The moving image generation server 20 sets the moving image at the time and the point specified by the user in the moving image setting as the clipping range. Examples of the above-described timing include a time of departure of a road trip and a time of arrival at a destination. The moving image generation server 20 sets such a clipping range on the basis of information on a shooting position and a shooting time included in the moving image data.
The moving image generation server 20 sets a range in which the person designated in the moving image setting is included in the moving image as the clipping range. The moving image generation server 20 identifies a person in the moving image by face recognition.
   The moving image generation server 20 sets the clipping range such that the time of the moving image to be generated is the time set in the moving image setting. Furthermore, when generating a moving image, the moving image generation server 20 inserts the music designated by the user in the moving image setting as the background music.

### Operational Effect of Embodiment

The operation of the moving image generation system of the present embodiment will be described.

In the present embodiment, the shot data of the drive recorder 11 during the load trip is transmitted to the moving image generation server 20 outside the vehicle. Then, the moving image generation server 20 sets the clipping range based on the analysis result of the moving image and the sound of the shot data, and generates a moving image obtained by clipping the moving image of the clipping range from the shot data as a load trip movie.

In the case where the analysis of the moving image and the audio for the generation of the moving image is performed in real time during the shooting of the drive recorder 11, it is necessary to mount an analysis device having a high processing capability on the vehicle 10. In the case of the present embodiment, the moving image and audio analysis for generating a moving image is performed by the moving image generation server 20 outside the vehicle after shooting. It is possible to automatically generate a road trip movie without mounting an analysis device having a high processing capacity on the vehicle 10.

As described above, in the present embodiment, it is possible to automatically generate a load trip movie using the shot data of the drive recorder 11 without mounting the analysis device having high processing capability on the vehicle 10. Therefore, the moving image generation system of the present embodiment has an effect of facilitating creation of a load trip movie.

### Other Embodiments

The present embodiment can be modified as follows. The present embodiment and the following modifications can be implemented in combination with each other as long as they are not technically contradictory.

A musical piece that has been played back in the vehicle during the shooting of the shooting data may be used for background music of a moving image to be generated. In this case, the moving image generation server 20 identifies the music piece being reproduced in the vehicle by the acoustic analysis of the shot data. Then, the moving image generation server 20 inserts the specified music into a moving picture to be generated as background music. At this time, the swelling portion of the image and the rust portion of the music piece may be synchronized.

The moving image setting and the sending instruction in S1, S2 of FIG. 2 may be performed by a user terminal (such as a PC) outside the vehicle. In this case, the shot data of the drive recorder 11 is moved or copied to the user terminal using a memory card or the like, and then transmitted from the user terminal to the moving image generation server 20. Further, the processing performed by the moving image generation server 20 may be performed by the user terminal. In this case, the user terminal configures the moving image generation system.

The processing related to the moving image generation performed by the moving image generation server 20 in the above-described embodiment may be performed in the vehicle 10. Also in this case, it is not necessary to perform real-time analysis of moving image and audio for generating a moving image. Therefore, the processing capability required for the processing device mounted on the vehicle 10 for generating a moving image can be kept low.

What is claimed is:

1. A moving image generation system that
sets a clipping range based on an analysis result of shooting data of a drive recorder, and also
automatically generates a moving image that is obtained by clipping an image of the clipping range from the shooting data.

2. The moving image generation system according to claim 1, wherein the clipping range is set based on sound in a vehicle, recorded in the shooting data.

3. The moving image generation system according to claim 1, wherein the clipping range is set based on a musical piece that was played in a vehicle during shooting of the shooting data.

4. The moving image generation system according to claim 1, wherein a musical piece that was played in a vehicle during shooting of the shooting data is used for background music of the moving image.

5. The moving image generation system according to claim 1, wherein a range in which a designated person is included in the image, or a range that starts at a period in which a person in the image performs a particular gesture, is set as the clipping range.
